(19) United States
(12) Patent Application Publication
(10) Pub. No.: US 2010/0121921 A1
(43) Pub. Date: May 13, 2010

(54) PROXIMITY BASED USER INTERFACE COLLABORATION BETWEEN DEVICES

(76) Inventor: Randy R. Dunton, Phoenix, AZ (US)

Correspondence Address: GARRETT IP, LLC, C/O CPA Global, P.O. BOX 52050, MINNEAPOLIS, MN, 55402, US

(21) Appl. No.: 12/267,688

(22) Filed: Nov. 10, 2008

(51) Int. Cl. G06F 15/16

(52) U.S. Cl. 709/205

(57) ABSTRACT

Techniques for proximity based user interface collaboration between devices. In an embodiment, a connected media center device or appliance (“MCA”) is adapted to receive multiple inputs supporting different sources of media or content. The MCA is further adapted to interact with a mobile device in such a way that when the two are within certain proximity of each other, the mobile device is able to act as a remote control for the MCA. Other embodiments may be described and claimed.

### BACKGROUND

Today's homes may have one or more means for receiving content displayed on a single device. For example, various electronic devices in the home may be networked together in such a way to provide a user with a means for entertainment via a connected media center device and a single display device. Each of these electronic devices typically receives, processes and/or stores content. Example electronic devices may include personal computers (PCs), televisions, digital video disk (DVD) players, video cassette recorder (VCR) players, compact disk (CD) players, set-top boxes (STBs), stereo receivers, audio/video receivers (AVRs), media centers, personal video recorders (PVRs), digital video recorders (DVRs), gaming devices, digital camcorders, digital cameras, blackberries, cellular phones, personal digital assistants (PDAs), mobile internet devices (MIDs), and so forth. The connected media device may also be adapted to receive content from multiple inputs representing Internet Protocol (IP) input connections, person-to-person (P2P) input connections, cable/satellite/broadcast input connections, DVB-H and DMB-T transceiver connections, ATSC and cable television tuners, UMTS and WiMAX MBMS/MBS, IPTV through DSL or Ethernet connections, WiMax and Wifi connections, Ethernet connections, and so forth.

Since the connected media center device is capable of providing a user with a large variety of media or entertainment options via the methods described above, the user interface of the connected media center device needs to be more advanced now than in the past. In addition, as the variety of media or entertainment options grows or changes over time, the user interface of the connected media center device needs to adapt to accommodate these changes.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates an embodiment of a system.

FIG. 2 illustrates an embodiment of a logic flow.

FIG. 3 illustrates an embodiment of a logic flow.

FIG. 4 illustrates an embodiment of a logic flow.

FIG. 5 illustrates an embodiment of a logic flow.

FIG. 6 illustrates an embodiment of a system.

FIG. 7 illustrates an embodiment of a device.

### DETAILED DESCRIPTION

Various embodiments may be generally directed to techniques for proximity based user interface collaboration between devices. In embodiments, a connected media center device or appliance (“MCA”) is adapted to receive multiple inputs supporting different sources of media or content. In embodiments, the MCA is further adapted to interact with a mobile device in such a way that when the two are within certain proximity of each other, the mobile device is able to act as a remote control for the MCA.

Here, in embodiments, the MCA and mobile device are adapted to include collaboration user interface logic and the ability to determine when the two are within certain proximity of each other. Once the MCA and mobile device are connected (and within certain proximity), they exchange information that is used to develop a collaboration user interface between the two. For example, the MCA may have a speech recognition application but no microphone for a user to enter voice data. The mobile device may have a microphone. In embodiments, the collaboration user interface allows the input features or interaction options or capabilities found on the mobile device to be used for one or more user interfaces or applications on the MCA. For example, the collaboration user interface facilitates the microphone on the mobile device to be used to enter voice data into the speech recognition application of the MCA. Embodiments of the invention are not limited in this context. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

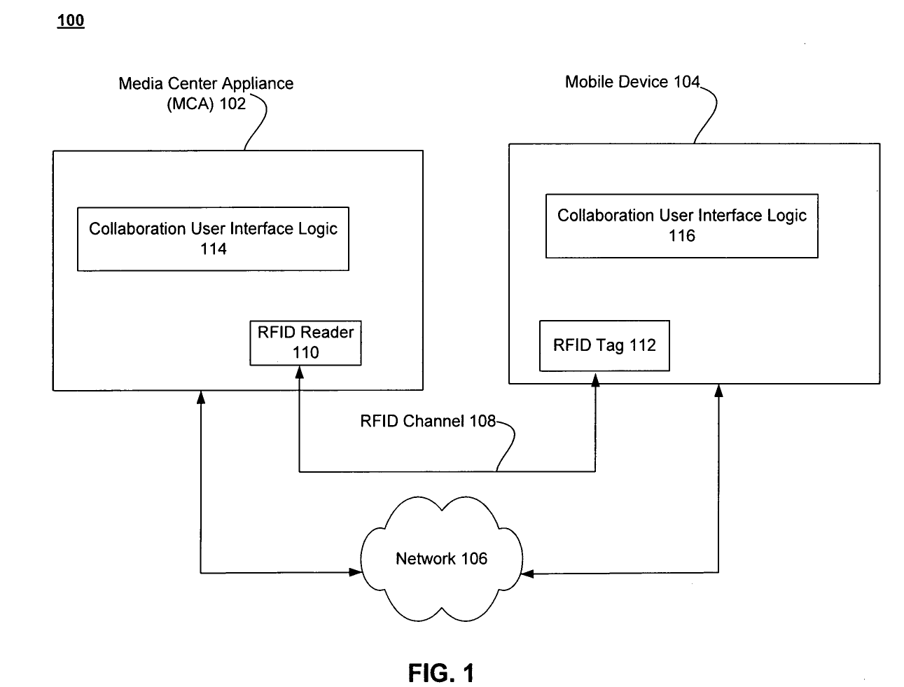

FIG. 1 illustrates an embodiment of a system 100. Referring to FIG. 1, system 100 may comprise a media center appliance (MCA) 102, a mobile device 104, a network 106 and a radio frequency identification (RFID) channel 108. MCA 102 may include a RFID reader 110 and collaboration user interface logic 114. Mobile device 104 may include a RFID tag 112 and collaboration user interface logic 116. Although only one MCA and one mobile device are shown in FIG. 1, this is not meant to limit embodiments of the invention. In fact, embodiments of the invention contemplate any number of MCAs and/or mobile devices. Each of these elements is described next in more detail.

In embodiments, MCA 102 may be any connected device capable of performing the functionality of the invention described herein. Examples may include, but are not limited to, a connected high-definition television (HDTV), a connected advanced set-top box (STB), and so forth. MCA 102 may be owned, borrowed or licensed by its respective user.

In embodiments, MCA 102 is adapted to receive multiple inputs supporting different sources of media or content. The multiple inputs may represent various types of connections including wired, wireless, infra-red, or some combination thereof. More specifically, the multiple inputs may represent Internet Protocol (IP) input connections, a peer-to-peer (P2P) input connection, broadcast/satellite/cable input connections, DVB-H and DMB-T transceiver connections, ATSC and cable television tuners, UMTS and WiMAX MBMS/MBS, IPTV through DSL or Ethernet connections, WiMax and Wifi connections, Ethernet connections, and inputs from various electronic devices. Example electronic devices may include, but are not limited to, televisions, DVD players, VCR players, CD or music players, STBs, stereo receivers, AVRs, media centers, PVRs, DVRs, gaming devices, digital camcorders, digital cameras, blackberries, cellular phones, PDAs, laptops, flash devices, MIDs, ultra-mobile PCs, MP3 players, and so forth. Embodiments of the invention are not limited in this context.

In embodiments, the content may be any type of content or data. Examples of content may generally include any data or signals representing information meant for a user, such as media information, voice information, video information, audio information, image information, textual information, numerical information, alphanumeric symbols, graphics, and so forth. Although embodiments of the invention are described herein as being applicable to home entertainment or media related environments, this is not meant to limit the invention. In fact, embodiments of the invention are applicable to many environments including, but not limited to, office environments, healthcare environments, educational environments, research environments, and so forth. The embodiments are not limited in this context.

In embodiments, MCA 102 may represent a device that includes personal video recorder (PVR) functionality. PVR functionality records television data (i.e., requested content) in digital format (e.g., MPEG-1 or MPEG-2 formats) and stores the data in a hard drive or on a server, for example. The data may also be stored in a distributed manner such as on one or more connected devices throughout an environment. In embodiments, a PVR could be used as a container for all things recorded, digital or other (e.g., DVRs).

In embodiments, MCA 102 may represent a device that includes one or more applications. Example applications may include speech recognition applications, searching applications, graphical user interface (GUI) applications, user identification applications, and so forth. Embodiments of the invention are not limited in this context.

Referring again to FIG. 1 and in embodiments, mobile device 104 may be any mobile or personal device capable of performing the functionality of the invention described herein. Device 104 may be implemented as part of a wired communication system, a wireless communication system, an infra-red system, or a combination thereof. In one embodiment, for example, device 104 may be implemented as a mobile computing device having wireless or infra-red capabilities. A mobile computing device may refer to any device which can be easily moved from place to place. In embodiments, the mobile computing device may include a processing system.

In embodiments, device 104 may include any mobile device that is adapted to include the functionality of the present invention, including but not necessarily limited to, a mobile internet device (MID), smart phone, handheld computer, palmtop computer, personal digital assistant (PDA), cellular telephone, combination cellular telephone/PDA, pager, one-way pager, two-way pager, messaging device, data communication device, MP3 player, laptop, ultra-mobile PC, smart universal remote control, and so forth.

In embodiments, mobile device 104 may represent a device that includes user input features or interaction options such as, but not limited to, a microphone, touch screen, gyroscope, keyboard, biometric data readers, screen size, types of media or content information stored and/or supported, and so forth. One or more of the interaction options may include haptic technology. In general, haptic technology refers to technology which interfaces to the user via the sense of touch by applying forces, vibrations and/or motions to the user.

In embodiments, when mobile device 104 is acting as a remote control for MCA 102 via the collaboration user interface, it may also act as a remote control for other devices in its environment. In embodiments, two or more mobile devices 104 may participate at once to create a collaboration user interface with MCA 102. For example, if a second mobile device were to be within certain proximity with MCA 102, it would be possible to have two people interacting collaboratively with the same MCA 102.

Network 106 of FIG. 1 facilitates communication between MCA 102 and mobile device 104. Network 106 may be a local area network (LAN), high speed Internet network, or any other type of network suited for the particular application. Network 106 may be wireless, infra-red, wired, or some combination thereof. Other types of networks may be added or substituted as new networks are developed.

RFID channel 108 allows for communication between RFID tag 112 in mobile device 104 and RFID reader 110 in MCA 102. RFID technology allows for the means to determine the rough proximity between MCA 102 and mobile device 104. RFID technology also facilitates MCA 102 to uniquely identify mobile device 104. Embodiments of the invention are not limited to RFID technology and contemplate the use of any technology that allows for the determination of the rough proximity and/or identification between two or more devices including, for example, Bluetooth technology.

In embodiments, once mobile device 104 is uniquely identified by MCA 102 (via, for example, RFID technology), MCA 102 and device 104 exchange user interface capability information with each other. In other embodiments, only device 104 sends user interface capability information to MCA 102. For example, MCA 102 may provide device 104 with the various applications it supports, the types of media or content information stored and/or supported, etc. As described above, example applications may include speech recognition applications, searching applications, graphical user interface (GUI) applications, identification applications, and so forth. In exchange, device 104 may provide MCA 102 with the various input features or interaction options it includes that might be useful to a user interface for MCA 102. As mentioned above, such interaction options may include a microphone, touch screen, gyroscope, keyboard, biometric data readers, screen size, types of media or content information stored and/or supported, etc. In embodiments, this information is exchanged via network 106.

In embodiments, collaboration user interface logic 114 of MCA 102 uses the provided interaction options of device 104 to create a MCA application or widget that includes counterpart user interface components for a collaboration user interface. The counterpart user interface components may include mobile device user interface components and MCA user interface components. The collaborative user interface is one between MCA 102 and mobile device 104.

In embodiments, MCA 102 transfers the MCA application or widget with the mobile device counterpart user interface components to mobile device 104 via collaboration user interface logic 116. Once downloaded to mobile device 104, the MCA application or widget appears as an icon on the mobile device user interface when the two are within a certain proximity to each other. Similarly, a mobile device icon may be displayed on the user interface of MCA 102 to indicate to a user that the two are connected and facilitate a collaboration user interface. In embodiments, when the MCA icon is activated, mobile device 104 acts as a remote control device for MCA 102 by having the mobile device user interface components interact with their counterpart MCA user interface components.

As described above and in embodiments, the collaboration user interface allows the input features or interaction options or capabilities found on mobile device 104 to be used for one or more user interfaces or applications on MCA 102. For example, MCA 102 may have a speech recognition application but no microphone for a user to enter voice data. Mobile device 104 may have a microphone. In embodiments, the collaboration user interface may facilitate the microphone on mobile device 104 to be used to enter voice data into the speech recognition application of MCA 102. In another example, MCA 102 may require a free-form pointing system to select among a number of options on a GUI displayed on a screen (e.g., to select an item like a television show or movie). Here, the collaboration user interface may facilitate a gyroscope or accelerometer of mobile device 104 to act as a gesture input device to MCA 102. In another example, MCA 102 may have a search box that needs to be filled in to search for content accessible via MCA 102. The collaboration user interface may enable the touch screen of mobile device 104 to act as a remote keyboard to MCA 102. In yet another example, the microphone of mobile device 104 may be used to send voice data to MCA 102 for automatic speech recognition as the input to the search. Embodiments of the invention are not limited to these examples.

In embodiments, mobile device 104 is personal to a user (i.e., not typically shared with another user). A personal mobile device is likely to store content and customizations that were created by its user. In embodiments, MCA 102 is able to uniquely identify mobile device 104 via, for example, its RFID tag 112. When mobile device 104 is personal to a user and is able to be uniquely identified by MCA 102, then MCA 102 may be able to uniquely identify the user of mobile device 104 and thus the user currently interacting with it via mobile device 104. Accordingly, mobile device 104 and MCA 102 are able to exchange personal information about a particular user.

The exchange of personal information about a particular user is useful for many reasons. For example, any recent user specific information such as play-lists or other entertainment preferences or customizations which are stored on mobile device 104 may be transferred to MCA 102. MCA 102 may use this information to update the user's profile, to provide more customized user interface options for the user, and so forth. Embodiments of the invention are not limited in this context.

In embodiments, the mobile device and MCA icons described above may be used to easily transfer files between MCA 102 and mobile device 104. For example, the user of mobile device 104 may wish to transfer a file to MCA 102. Here, the user may use a drag and drop action to drag a file on the GUI of mobile device 104 and to drop the file on the MCA icon located on the same GUI. In embodiments, the file will automatically be transferred to MCA 102 via network 106. The user may similarly transfer a file from MCA 102 to mobile device 104 via the mobile device icon located on the GUI of MCA 102. Once transferred, the file appears on the device it was transferred to and can be dealt with accordingly (e.g., stored, played, attached to email, etc.).

Embodiments of the invention provide for many advantages over what currently exist today. People, in general, expect or desire things to work together in an intuitive way when it comes to devices connected together on a network. This is generally not an easy thing to accomplish, considering that every device on the network likely has its own remote control and user interface. Several aspects of the invention described above facilitate devices to more easily or intuitively work together in a networked environment. One aspect is the ability for two or more devices to be aware of each based on physical proximity. Once near each other, the devices are able to share attributes or capabilities particular to each device and use the shared capabilities to optimize a collaboration user interface between the devices. The collaboration user interface is a relevant user interface between the devices because the collaboration user interface is dynamically created between the two devices based on each device's current capabilities. Another advantage of embodiments of the invention allows the GUI of each device to remain uncluttered until the devices are within a certain proximity to each other.

As described above, the collaboration user interface is a relevant user interface between the devices. The dynamic nature of the collaboration user interface allows for updates and new features of each device to easily ripple through the collaboration user interface. For example, if the mobile device was upgraded to include a gyroscope or accelerometer, the MCA will become aware of the upgrade the next time the two devices are within a certain proximity and exchange capabilities to create the collaboration user interface. Another example may include if the MCA is upgraded to include speech recognition software. Here, in embodiments, the collaboration user interface will check all devices within certain proximity for the needed input, such as a microphone.

Another advantage of embodiments of the invention is that the collaboration user interface becomes more familiar and consistent in the environment it is used. For example, when the keyboard is presented locally on the mobile device, it may be created on the MCA with the MCA's colors, behavior and styles. The GUI on the MCA (or television screen, for example) may use the same colors, behavior and styles as the one sent to the mobile device. The mobile device, then part of the MCA, becomes an extension of the user interface of the MCA allowing the user to once learn how the MCA works and no matter what mobile device pairs up with it via a collaboration user interface, the look, feel and behavior are maintained.

In various embodiments, system 100 of FIG. 1 may be implemented as a wireless system, a wired system, an infra-red system, or some combination thereof. When implemented as a wireless system, system 100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Operations for the embodiments described herein may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments, however, are not limited to the elements or in the context shown or described in the figures.

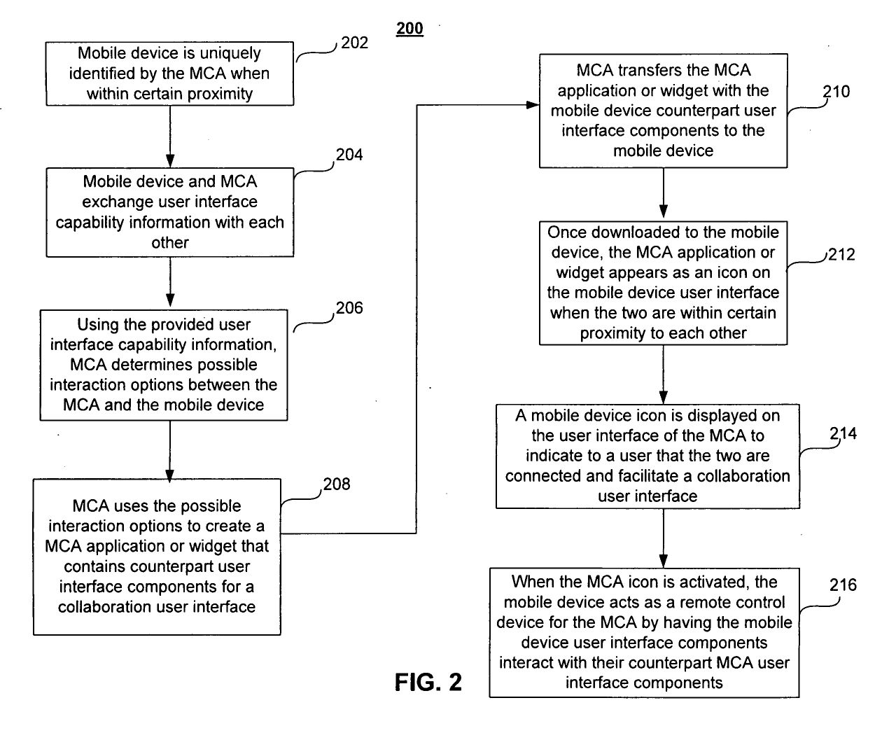

FIG. 2 illustrates one embodiment of a logic flow 200. As shown in logic flow 200, a mobile device (such as mobile device 104 from FIG. 1) is uniquely identified by a MCA (such as MCA 102 from FIG. 1) when the two are within certain proximity of each other (block 202). As described above and in an embodiment, RFID technology (such as RFID channel 108, RFID reader 110 and RFID tag 112 from FIG. 1) allows for determination of the rough proximity between the MCA and mobile device. RFID technology may also allow the MCA to uniquely identify the mobile device.

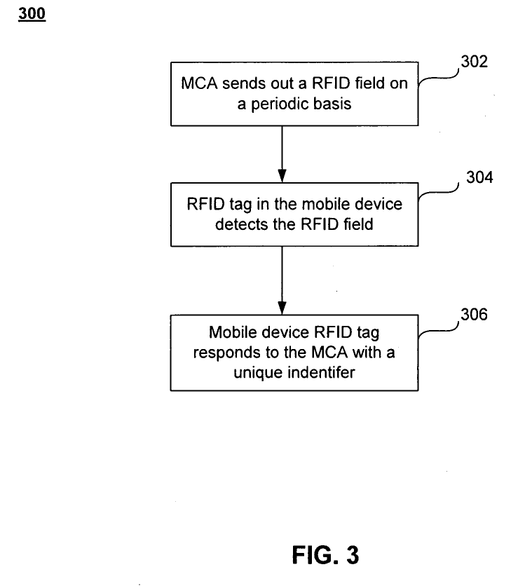

FIG. 3 illustrates an embodiment of a logic flow of determining certain proximity and identification of devices. Referring to FIG. 3, the MCA sends out a RFID field on a periodic basis (block 302). The RFID tag in the mobile device detects the RFID field (block 304). The RFID tag responds to the MCA with a unique identifier (block 306).

Embodiments of the invention are not limited to RFID technology and contemplate the use of any technology that allows for the determination of the rough proximity and/or identification between two or more devices.

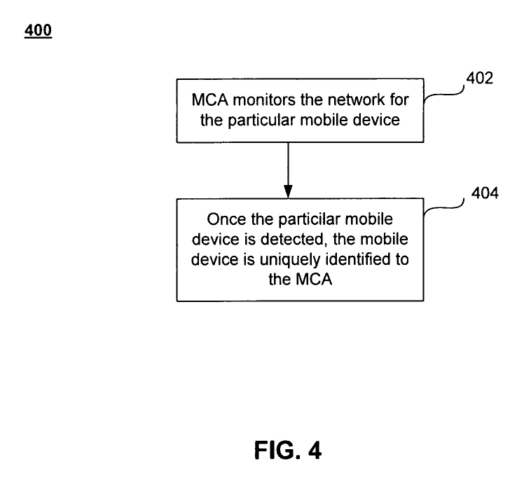

FIG. 4 illustrates another embodiment of a logic flow of determining certain proximity and identification of devices. Referring to FIG. 4, the MCA monitors the network for the particular mobile device (block 402). Once the particular mobile device is detected, the mobile device is uniquely identified to the MCA (block 404). In embodiments, the MCA may wake up the mobile device from a lower power conserving state and cause the mobile device to turn on its wireless LAN network adapter, for example.

Referring again to FIG. 2 and as described above, the mobile device and MCA exchange user interface capability information with each other (block 204). In other embodiments, only the mobile device sends user interface capability information to the MCA. Using the provided user interface capability information, the MCA determines possible interaction options between the MCA and the mobile device, as described above (block 206).

The MCA uses the possible interaction options to create a MCA application or widget that contains counterpart user interface components for a collaboration user interface, as described above (block 208). The MCA then transfers the MCA application or widget with the mobile device counterpart user interface components to the mobile device (block 210).

Once downloaded to the mobile device, the MCA application or widget appears as an icon on the mobile device user interface when the two devices are within certain proximity to each other (block 212). A mobile device icon is displayed on the user interface of the MCA to indicate to a user that the two devices are connected and facilitate a collaboration user interface (block 214).

When the MCA icon is activated, the mobile device acts as a remote control device for the MCA by having the mobile device user interface components interact with their counterpart MCA user interface components (block 216).

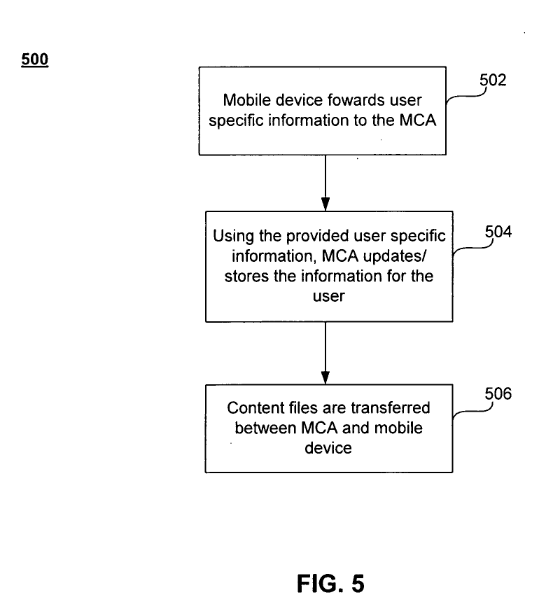

FIG. 5 illustrates an embodiment of a logic flow. Referring to FIG. 5, the mobile device forwards user specific information to the MCA, as described above (block 502). Using the provided user specific information, the MCA updates/stores the information for the user (block 504). Content files may be transferred between the MCA and mobile device via a drag and drop action on the relevant icons, as described above (block 506).

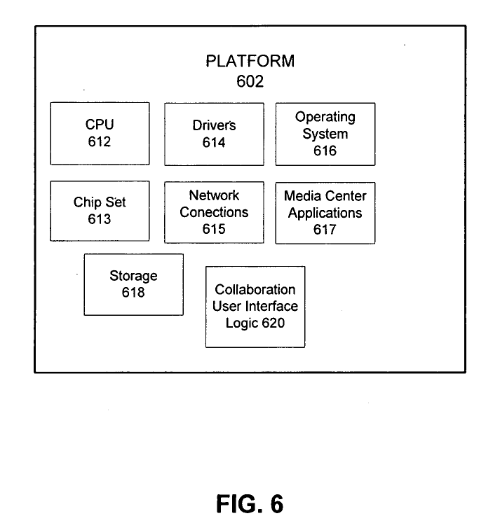

FIG. 6 illustrates an embodiment of a platform 602 in which functionality of the present invention as described herein may be implemented. In one embodiment, platform 602 may comprise or may be implemented as a media platform 602 such as the Viiv™ media platform made by Intel® Corporation. In one embodiment, platform 602 may accept multiple inputs, as described above.

In one embodiment, platform 602 may comprise a CPU 612, a chip set 613, one or more drivers 614, one or more network connections 615, an operating system 616, and/or one or more media center applications 617 comprising one or more software applications, for example. Platform 602 also may comprise storage 618, and collaboration user interface logic 620.

In one embodiment, CPU 612 may comprise one or more processors such as dual-core processors. Examples of dual-core processors include the Pentium® D processor and the Pentium® processor Extreme Edition both made by Intel® Corporation, which may be referred to as the Intel Core Duo® processors, for example.

In one embodiment, chip set 613 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 614 may comprise the Quick Resume Technology Drivers made by Intel® to enable users to instantly turn on and off platform 602 like a television with the touch of a button after initial boot-up, when enabled, for example. In addition, chip set 613 may comprise hardware and/or software support for 5.1 surround sound audio and/or high definition 7.1 surround sound audio, for example. Drivers 614 may include a graphics driver for integrated graphics platforms. In one embodiment, the graphics driver may comprise a peripheral component interconnect (PCI) Express graphics card.

In one embodiment, network connections 615 may comprise the PRO/1000 PM or PRO/100 VE/VM network connection, both made by Intel® Corporation.

In one embodiment, operating system 616 may comprise the Windows® XP Media Center made by Microsoft® Corporation. In other embodiments, operating system 616 may comprise Linux®, as well as other types of operating systems. In one embodiment, one or more media center applications 617 may comprise a media shell to enable users to interact with a remote control device from a distance of about 10-feet away from platform 602 or a display device, for example. In one embodiment, the media shell may be referred to as a “10-feet user interface,” for example. In addition, one or more media center applications 617 may comprise the Quick Resume Technology made by Intel®, which allows instant on/off functionality and may allow platform 602 to stream content to media adaptors when the platform is turned “off.”

In one embodiment, storage 618 may comprise the Matrix Storage technology made by Intel® to increase the storage performance enhanced protection for valuable digital media when multiple hard drives are included. In one embodiment, collaboration user interface logic 620 is used to enable the functionality of the invention as described herein. The embodiments, however, are not limited to the elements or in the context shown or described in FIG. 6.

Platform 602 may establish one or more logical or physical channels to communicate information. The information may include media information and control information. Media information may refer to any data representing content meant for a user. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

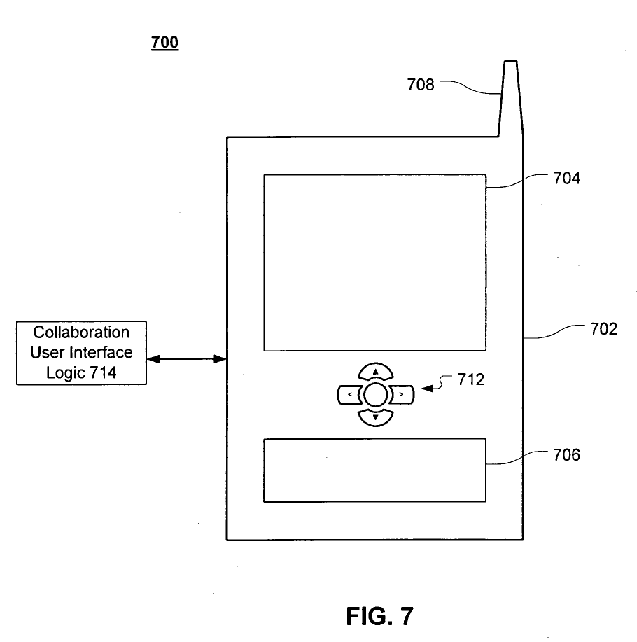

FIG. 7 illustrates one embodiment of a device 700 in which functionality of the present invention as described herein may be implemented. In one embodiment, for example, device 700 may comprise a communication system. In various embodiments, device 700 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, blackberry, MID, MP3 player, and so forth. The embodiments are not limited in this context.

In one embodiment, device 700 may be implemented as part of a wired communication system, a wireless communication system, or a combination of both. In one embodiment, for example, device 700 may be implemented as a mobile computing device having wireless capabilities. A mobile computing device may refer to any device having a processing system and a mobile power source or supply, such as one or more batteries, for example.

Examples of a mobile computing device may include a laptop computer, ultra-mobile PC, portable computer, handheld computer, palmtop computer, personal digital assistant (PDA), cellular telephone, combination cellular telephone/PDA, smart phone, pager, one-way pager, two-way pager, messaging device, data communication device, MID, MP3 player, and so forth.

In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may comprise a housing 702, a display 704, an input/output (I/O) device 706, and an antenna 708. Device 700 also may comprise a five-way navigation button 712. I/O device 706 may comprise a suitable keyboard, a microphone, and/or a speaker, for example. Display 704 may comprise any suitable display unit for displaying information appropriate for a mobile computing device. I/O device 706 may comprise any suitable I/O device for entering information into a mobile computing device. Examples for I/O device 706 may include an alphanumeric keyboard, a numeric keypad, a touch pad, input keys, buttons, switches, rocker switches, voice recognition device and software, and so forth. Information also may be entered into device 700 by way of microphone. Such information may be digitized by a voice recognition device. The embodiments are not limited in this context.

In embodiments, device 700 is adapted to include collaboration user interface logic 714. In one embodiment, collaboration user interface logic 714 is used to enable the functionality of the invention as described herein.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multicore processor. In a further embodiment, the functions may be implemented in a consumer electronics device.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
determining that a first device and a second device are within certain proximity of each other;
exchanging user interface capabilities between the first and second devices; and
creating a collaboration user interface based on the exchanged user interface capabilities.

2. The method of claim 1, further comprising:
activating the collaboration user interface such that the second device operates as a remote control device for the first device.

3. The method of claim 2, wherein the collaboration user interface represents one or more interaction options between the first and second devices.

4. The method of claim 3, wherein the first device is a media center appliance (MCA) and the second device is a mobile device.

5. The method of claim 4, wherein the collaboration user interface is activated by activating a MCA icon on a graphical user interface (GUI) of the mobile device and wherein the MCA icon is displayed only when the MCA and the mobile device are within certain proximity of each other.

6. The method of claim 1, wherein the collaboration user interface is dynamically created each time the first and second devices are within certain proximity of each other.

7. The method of claim 1, further comprising:
identifying the second device by the first device via one of radio frequency identification (RFID) technology and Bluetooth technology.

8. A system, comprising:
a first device adapted to determine when a second device is within close proximity, wherein the first device is adapted to receive user interface capabilities of the second device, wherein the first device is adapted to create a collaboration user interface based on the user interface capabilities of the first and second devices, wherein the first device is adapted to determine when the collaboration user interface is activated on the second device, and, once activated, the first device is adapted to be remotely controlled by the second device.

9. The system of claim 8, wherein the first device is adapted to display a second device icon on a graphical user interface (GUI) to indicate that the first and second devices facilitate the collaboration user interface.

10. The system of claim 9, wherein the second device icon is displayed on the GUI only when the first and second devices are within close proximity.

11. The system of claim 8, wherein the collaboration user interface represents one or more interaction options between the first and second devices.

12. The system of claim 8, wherein the collaboration user interface is dynamically created each time the first and second devices are within certain proximity of each other.

13. The system of claim 8, wherein the first device is a media center appliance (MCA) and the second device is a mobile device.

14. A machine-readable storage medium containing instructions which, when executed by a processing system, cause the processing system to perform a method, the method comprising:
determining that a first device and a second device are within certain proximity of each other;
exchanging user interface capabilities between the first and second devices; and
creating a collaboration user interface based on the exchanged user interface capabilities.

15. The machine-readable storage medium of claim 14, further comprising:
activating the collaboration user interface such that the second device operates as a remote control device for the first device.

16. The machine-readable storage medium of claim 15, wherein the collaboration user interface represents one or more interaction options between the first and second devices.

17. The machine-readable storage medium of claim 16, wherein the first device is a media center appliance (MCA) and the second device is a mobile device.

18. The machine-readable storage medium of claim 17, wherein the collaboration user interface is activated by activating a MCA icon on a graphical user interface (GUI) of the mobile device and wherein the MCA icon is displayed only when the MCA and the mobile device are within certain proximity of each other.

19. The machine-readable storage medium of claim 14, wherein the collaboration user interface is dynamically created each time the first and second devices are within certain proximity of each other.

20. The machine-readable storage medium of claim 14, further comprising:
identifying the second device by the first device via one of radio frequency identification (RFID) technology and Bluetooth technology
